(19) United States
(12) Patent Application Publication
(10) Pub. No.: US 2026/0278944 A1
(43) Pub. Date: Sep. 17, 2026

(54) MULTIPLE PARTICIPANT AND OBJECT INTERACTIONS THROUGH A VIRTUAL PORTAL IN A VIRTUAL SPACE OF EXTENDED REALITY ENVIRONMENT

(71) Applicant: Telefonaktiebolaget LM Ericsson (publ), Stockholm (SE)

(72) Inventors: Tommy ARNGREN, SÖDRA SUNDERBYN (SE); Peter ÖKVIST, LULEÅ (SE); Niklas LINDSKOG, LUND (SE)

(73) Assignee: Telefonaktiebolaget LM Ericsson (publ), Stockholm (SE)

(21) Appl. No.: 19/471,318

(22) PCT Filed: Mar. 30, 2023
(86) PCT No.: PCT/EP2023/058223

§ 371 Date: Sep. 30, 2025

(51) Int. Cl. G06T 19/00; G06T 7/13; G06T 7/246

(52) U.S. Cl. CPC G06T 19/00; G06T 7/13; G06T 7/246; G06T 2200/24; G06T 2207/10024; G06T 2210/62; G06T 2219/024

(57) ABSTRACT

An XR rendering device for rendering an immersive XR environment on a display device for viewing by a second participant in the immersive XR environment. The XR rendering device includes a processor circuitry adapted to perform operations. The operations include obtaining parameters defining a first virtual portal having a three-dimensional volume at a location in physical space of a first participant. The operations also include tracking a location of a physical object relative to the three-dimensional volume of the first virtual portal. The operations also include rendering a virtual object representation of the physical object in a second virtual portal for viewing by the second participant responsive to determining the physical object has entered the first virtual portal.

### TECHNICAL FIELD

The present disclosure relates to rendering extended reality (XR) environments and associated XR rendering devices, and more particularly to rendering objects in immersive XR environments for display on XR participant devices.

### BACKGROUND

Immersive extended reality (XR) environments have been developed which provide a myriad of different types of participant experiences for gaming, on-line meetings, co-creation of products, etc. One type of immersive XR environments (also referred to as “XR environments”) is virtual reality (VR) environments where human participants only see computer generated graphical renderings. Another type of XR environment is augmented reality (AR) environments where participants see a combination of computer-generated graphical renderings overlaid on a view of the physical real-world through, e.g., see-through display screens.

Example XR environment rendering devices include, without limitation, XR environment servers, XR headsets, gaming consoles, smartphones running an XR application, and tablet/laptop/desktop computers running an XR application. Oculus Quest is an example VR device with AR functionality and Google Glass is an example AR device.

XR meeting applications are tools for experiencing online immersive meetings and are useful as a thinking and planning space for oneself as well as among a group of people. Some XR meeting applications support AR devices, browsers, and VR devices. A participant using a browser may join via desktop, tablet-PC or smartphone and share their views using a front faced cam or a web cam. Some XR meeting solutions have mobile application versions, e.g., Android and iOS, which allow a participant to navigate in the virtual space on the screen or activate an AR mode to display the meeting in their own surroundings. The XR meeting solutions introduce new features to online meetings that allow for new ways to share and create content etc. Today's commonly and commercially available XR devices typically include a head-mounted device (HMD) and a pair of hand controllers, sometimes with more advanced solutions including “foot controllers”.

Immersive XR environments, such as gaming environments and meeting environments, are often configured to display computer generated avatars which represent poses of human participants in the immersive XR environments. Participants can interact with virtual objects that are rendered in the immersive XR environment, such as by controlling their avatars to manipulate virtual objects. Immersive XR environments presently support little if any interface between physical objects and virtual objects that are rendered.

### SUMMARY

Some embodiments disclosed herein are directed to an extended reality (XR) rendering device for rendering an immersive XR environment on a display device for viewing by a second participant in the immersive XR environment. The XR rendering device includes a processor circuitry adapted to perform operations. The operations include obtaining parameters defining a first virtual portal having a three-dimensional volume at a location in physical space of a first participant. The operations also include tracking a location of a physical object relative to the three-dimensional volume of the first virtual portal. The operations also include rendering a virtual object representation of the physical object in a second virtual portal for viewing by the second participant responsive to determining the physical object has entered the first virtual portal.

Some other embodiments are directed to a corresponding method by an XR rendering device for rendering an immersive XR environment on a display device for viewing by a second participant in the immersive XR environment. The method includes obtaining parameters defining a first virtual portal having a three-dimensional volume at a location in physical space of a first participant. The method also includes tracking a location of a physical object relative to the three-dimensional volume of the first virtual portal. The method also includes, responsive to determining the physical object has entered the first virtual portal, rendering a virtual object representation of the physical object in a second virtual portal for viewing by the second participant.

Some other embodiments are directed to a corresponding computer program product including a non-transitory computer readable medium storing instructions executable by at least one processor of XR rendering device rendering an immersive XR environment on a display device for viewing by a second participant in the immersive XR environment. The instructions executed by the at least one processor perform operations including obtaining parameters defining a first virtual portal having a three-dimensional volume at a location in physical space of a first participant. The operations also include tracking a location of a physical object relative to the three-dimensional volume of the first virtual portal. The operations also include, responsive to determining the physical object has entered the first virtual portal, rendering a virtual object representation of the physical object in a second virtual portal for viewing by the second participant.

Some potential advantages of these embodiments are that they enable a virtual portal where a participant and/or a system may associate certain rules for joint and/or time-parallel object interactions. Such embodiments may relate to object persistency as well as object participant-access while being in a virtual portal volume. As will be explained in further detail below, what operational function(s), rendered information, and interactions are allowed to be controlled and/or interacted with may be constrained by access rules and/or recipient-sender trust relations.

Other XR rendering devices, methods, and computer program products according to embodiments will be or become apparent to one with skill in the art upon review of the following drawings and detailed description. It is intended that all such additional XR rendering devices, methods, and computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 illustrates an XR system that includes a physical electronic device and a plurality of participant devices that communicate through networks with an XR rendering device to operate in accordance with some embodiments of the present disclosure;

FIG. 2 is an example illustration of the XR rendering device tracking location of a physical object relative to a three-dimensional volume of a first virtual portal in the first participant's physical space while the physical object is being rendered in a three-dimensional virtual space of the immersive XR environment, in accordance with some embodiments of the present disclosure;

FIG. 3 is an example illustration of the XR rendering device tracking location of a physical object relative to a three-dimensional volume of a first virtual portal in the first participant's physical space while the physical object is being rendered in virtual spaces of the immersive XR environment for a second participant and third participant, in accordance with some embodiments of the present disclosure;

FIG. 4 illustrates an example virtual portal with a virtual user interface (UI) displaying the content of the UI of a physical smartphone, in accordance with some embodiments of the present disclosure;

FIGS. 5-9 are flowcharts of operations that can be performed by an XR rendering device in accordance with some embodiments of the present disclosure;

FIG. 10 is a block diagram of components of an XR rendering device that are configured to operate in accordance with some embodiments of the present disclosure; and

FIG. 11 is a block diagram of components of an electronic device that are configured to operate in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

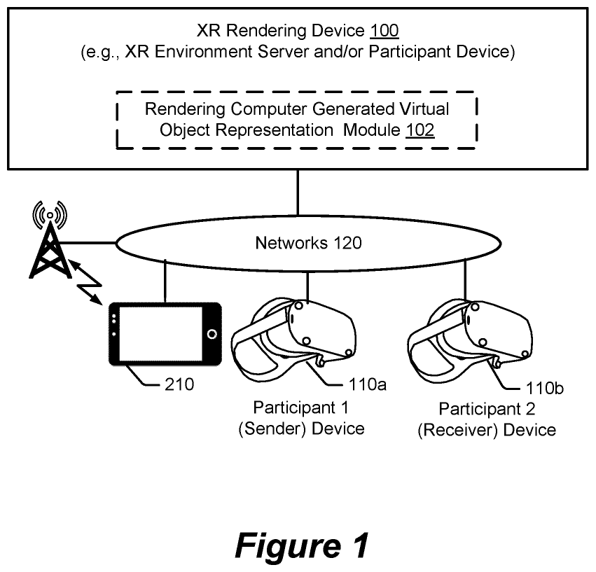

FIG. 1 illustrates an XR system that includes a physical object 210 and a plurality of participant devices 110a and 110b that communicate through networks 120 with an XR rendering device 100 to operate in accordance with some embodiments of the present disclosure. The XR rendering device 100 is configured to generate a graphical representation of an immersive XR environment (also called an “XR environment” for brevity) with a rendering computer generated virtual object representation module 102 which is viewable by human participants in the XR environment through display screens of the various participant devices 110a-b and/or a physical object 210, such as an XR headset 110a-b or smartphone 210 connected to the network 120.

For example, the illustrated devices of FIG. 1 include XR headsets 110a and 110b which can be worn by participants to view and navigate through the XR environment. The participant devices are not limited to XR headsets, as they could be a personal computer, tablet computers, smart phone, or other electronic device which can be operated by a participant to view and navigate through the XR environment. The participants may have associated avatars which are rendered in the XR environment to represent poses (e.g., location, body assembly orientation, etc.) of the participants relative to a coordinate system of the XR environment.

A physical object 210 while illustrated in FIG. 1 as a smartphone, may be any object which the participants choose to display and/or interact with in a virtual portal. The physical object may have electronic operation(s) which can be controlled through a user interface. The physical object 210 may be any type of electronic device that has a user interface. Alternatively, the physical object may also be a non-electronic object. Non-limiting examples of physical objects include food, non-electronic goods, smart phones, personal computers, table computers, smart appliances, etc. Non-limiting examples of user interfaces include touch screens and other display devices that can display participant selectable indicia and/or participant selectable menus, and physical buttons, touch sensor interfaces, etc.

As will be explained in further detail below in accordance with some embodiments, a representation of the physical object 210 is rendered in the XR environment as a virtual electronic device with a virtual representation of a user interface of the physical object 210. A participant in the XR environment can interact with the virtual user interface in order to control various electronic operational function(s) of the physical object 210.

Although the XR rendering device 100 is illustrated in FIG. 1 as being a centralized network computing server separate from one or more of the participant devices, in some other embodiments the XR rendering device 100 is implemented as a component of one or more of the participant devices. For example, one of the participant devices may be configured to perform operations of the XR rendering device in a centralized manner controlling rendering for or by other ones of the participant devices. Alternatively, each of the participant devices may be configured to perform at least some of the operations of the XR rendering device in a distributed decentralized manner with coordinated communications being performed between the distributed XR rendering devices (e.g., between software instances of XR rendering devices).

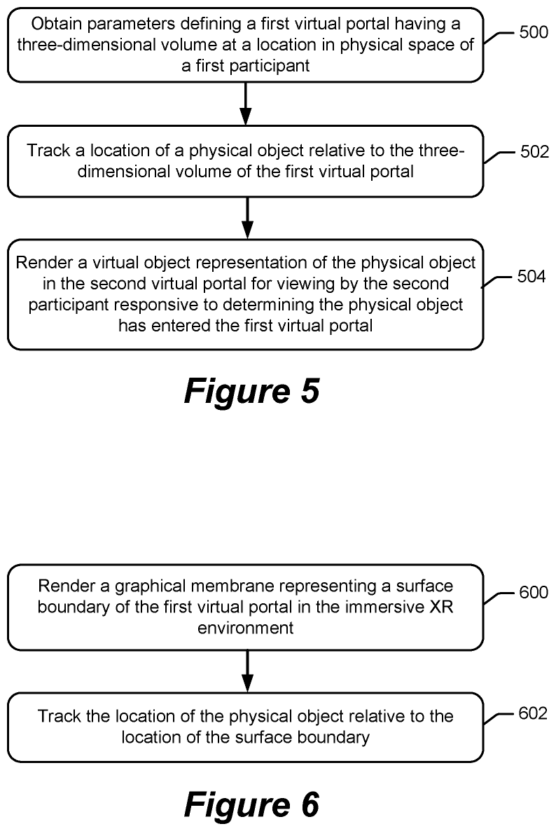

FIG. 5 is a flowchart of operations that can be performed by an XR rendering device in accordance with some embodiments of the present disclosure.

Referring to FIGS. 1 and 5, some embodiments of the present disclosure are directed to an extended reality (XR) rendering device 100 for rendering an immersive XR environment on a display device for viewing by a second participant in the immersive XR environment. The XR rendering device 100 includes a processor circuitry adapted to perform operations. The operations include obtaining 500 parameters defining a first virtual portal having a three-dimensional volume at a location in physical space of a first participant. The operations also include tracking 502 a location of a physical object 210 relative to the three-dimensional volume of the first virtual portal. The operations also include rendering 504 a virtual object representation of the physical object 210 in a second virtual portal for viewing by the second participant responsive to determining the physical object 210 has entered the first virtual portal.

In some embodiments, the XR rendering device enables one or more participants in an immersive XR environment to place a physical object into a three-dimensional volume of one or more virtual portals located in physical space, to trigger the XR rendering device 100 to render a virtual electronic device representing the physical object in the immersive XR environment. In an illustrative example, a first participant may reach a physical object 210, such as a smartphone, into a three-dimensional volume of the virtual portal to trigger the XR rendering device 100 to render a computer-generated virtual representation of the smartphone in the immersive XR environment. The first participant may view the physical smartphone while the second participant may view the corresponding virtual smartphone. In some embodiments, both the first participant and another, second, participant may simultaneously view the virtual smartphone. The second participant may similarly reach another smartphone into a three-dimensional volume of the same or another virtual portal displayed in the physical space of the second participant, to trigger rendering of another virtual smartphone. The second participant may then interact with the virtual smartphone of the first participant. The first and second participant may be provided corresponding feedback of the virtual interaction with the virtual smartphone, e.g., as tactile, audible, and/or visual feedback initiated by the XR rendering device 100 and provided through a tactile device, such as gloves or smart fabric, worn by the first and second participants. As will be appreciated in view of the description provided below, the type of physical object that can be passed through a virtual portal for rendering and possible interaction with by participants in the immersive XR environment is not limited by any of the operational embodiments herein.

In another illustrative example, the first participant may reach the physical object 210 into the three-dimensional volume of the virtual portal to trigger the XR rendering device 100 to render a computer-generated virtual representation of the physical object as a virtual object in the immersive XR environment. The virtual object may then be visible to other participants, such as the second participant, while the first participant still views the physical object 210 which the first participant is holding inside the virtual portal.

The XR rendering device 100 may be a single computing device or may be a distributed system of computing devices, e.g., computer servers, connected via one or more networks, such as a cloud computing environment. A non-limiting example of a XR rendering device is the cloud computing environment provided by Meta which includes numerous networked computing devices which host VR gaming environments serving Oculus VR headsets worn by remote participants.

The second participant can interact with the virtual user interface in the immersive XR environment by controlling an avatar representing the second participant, or physical body part of the second participant interacting with the virtual electronic device. The second participant may additionally or alternatively interact with the virtual user interface through the computer tracking of the second participant's physical hand interacting with the virtual user interface of the virtual electronic device.

The rendering of the virtual object may be provided to a device of the participant and/or one or more other participants for viewing and possible interaction with. XR headsets can be worn by participants in the immersive XR environment to provide an intuitive way for the participants to view the rendered virtual object and possibly also view a rendering of the virtual portal.

Some potential advantages of these embodiments are that they enable a virtual portal where a participant and/or a system may associate certain rules for joint and/or time-parallel object interactions. Such embodiments may relate to object persistency as well as object participant-access while being in a virtual portal volume. As will be explained in further detail below, what operational function(s), rendered information, and interactions are allowed to be controlled and/or interacted with may be constrained by access rules and/or recipient-sender trust relations.

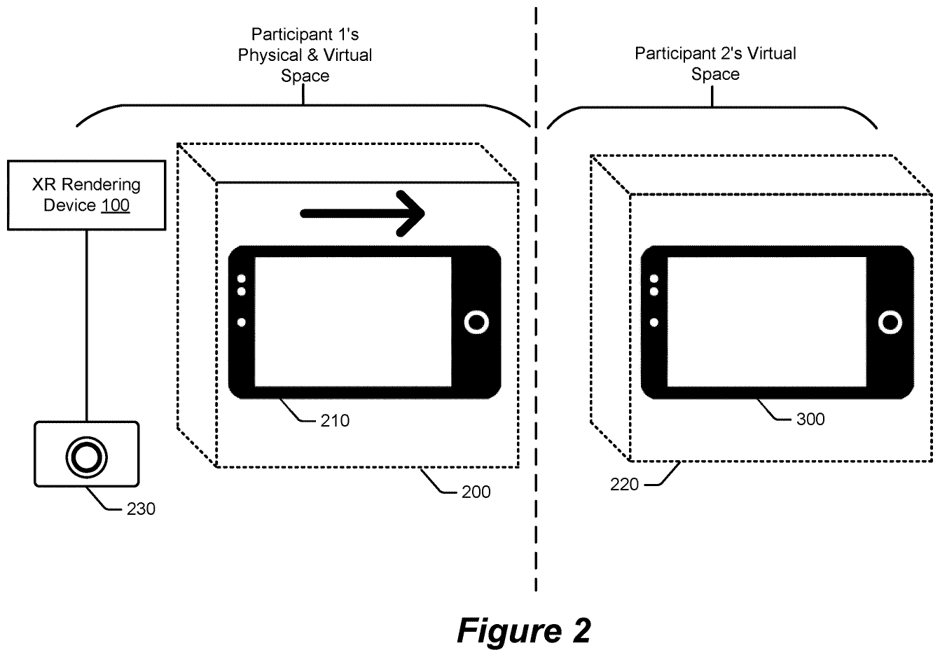

FIG. 2 is an example illustration of the XR rendering device 100 tracking location of a physical object 210 in the first participant's physical space while the physical object 210 is being passed through a virtual portal 200 and rendered in the virtual space of the immersive XR environment, in accordance with some embodiments of the present disclosure. Referring to FIG. 2, Participant 1 and Participant 2 are present participants in an immersive XR environment rendered by the XR rendering device 100. Participant 1 and Participant 2 can simultaneously view virtual objects that are rendered by the XR rendering device 100 in their respective virtual spaces, such as through XR headsets worn by the participants. The XR rendering device 100 is communicatively coupled to at least one sensor 230 that tracks location of a physical object 210, e.g., a smart phone, relative to the boundary of a virtual portal 200 having a location defined in physical space. The sensor 230 may be one or more cameras mounted to an XR headset and facing forward in the wearer's eye gaze direction.

The sensor 230 may additionally or alternatively be other types of sensors able to track location of physical objects, such as LIDAR sensors, ultrasound sensors, etc. In some embodiments, two cameras may be used to track location of the physical object 210 in three-dimensional (3D) space or a single LIDAR sensor may be used. LIDAR and one or more cameras may be used together to track and determine location, shape, texture, temperature, tactile notification, and color of the physical object 210. Alternatively, or additionally, the XR headset or other device transported by a participant may contain a sensor(s) that can track pose, such as an inertial measurement unit, and report the pose (e.g., location, head orientation, etc.) to the XR rendering device 100.

The virtual portal 200 or 220 may be any shape or size. In some embodiments, the virtual portal is a three-dimensional (3D) shape having a volume, such as a box or sphere. The virtual portal 200 has a surface boundary which are coordinates in 3D space indicating the edges of the 3D space which are tracked relative to the physical object 210 to determine when the physical object 210 has made contact and/or entered the surface boundary of the virtual portal 200 or 220.

The surface boundary of the virtual portal 200 or 220 may be visually represented for the participants with a graphical membrane in the immersive XR environment indicating a location of the surface boundary.

FIG. 6 is a flowchart of operations that can be performed by an XR rendering device in accordance with some embodiments of the present disclosure.

Referring to FIGS. 2 and 6, in some embodiments, operations further include rendering 600 a graphical membrane representing a surface boundary of the first virtual portal 200 in the immersive XR environment. The operations also include tracking 602 the location of the physical object 210 relative to the location of the surface boundary. The rendering of the virtual object representation of the physical object 210 is initiated based on determining the physical object 210 has entered the surface boundary.

In a first step, the initiative taking participant (first participant) triggers rendering of a virtual portal membrane located at a local coordinate system located with origin at (0,0,0) and with a participant-selected, context-based and/or default 2D size (“area”), in which respective x- and y-axis define the size of the virtual portal membrane. Trigger of virtual portal membrane rendering, and associated functionality may be invoked by participant gesture(s), application signal, or voice command.

In a second step, participant may trigger extension of the 2D membrane into a 3D object a.k.a. virtual portal volume (VPV) where the VPV at first participant side is indicated with a “depth” value in the local coordinate system according to Δz [length units].

In the second step the “depth” Δz may be indicated by e.g., first participant pushing the membrane (indicating with hand/hand controller to fetch membrane area element) along the z-axis, and releasing the hand controller at desired z-location.

In steps occurring simultaneously in time as step 1 and step 2, the XR rendering device 100 may as response to the first participant's step 1 render a 2D area corresponding to a VP membrane.

In steps occurring simultaneously in time as step 1 and step 2, the XR rendering device 100 may also as a response to the first participant's step 2 render an associated 3D volume virtual portal with a depth value related to the push-length Δz [length units] at first participant's side. In aspects of these embodiments, participant-preferences or system settings may suggest rendering of the virtual portal volume at the second side either as “−Δz” away from second participant, or “+Δz” towards the second participant. The participant-preferences or system settings may also define “k*Δz” where k is a scaling factor k_min≤k≤k_max, where k_min and/or k_max<0.

The first and/or second participant may manually adjust width, height and depth of the volume of the virtual portal, and priority and/or consensus policies may apply.

In some embodiments, the first and second virtual portals each have a set of defined attributes, wherein each of the sets of defined attributes include at least one of: shape of the three-dimensional volume of a respective one of the first and second virtual portals; texture of a graphical membrane representing a surface boundary of the respective one of the first and second virtual portals; volume surface color of the graphical membrane of the respective one of the first and second virtual portals; volume surface transparency of the graphical membrane of the respective one of the first and second virtual portals; time persistence of the respective one of the first and second virtual portals; and user access permission for interaction with the virtual object rendered in the respective one of the first and second virtual portals.

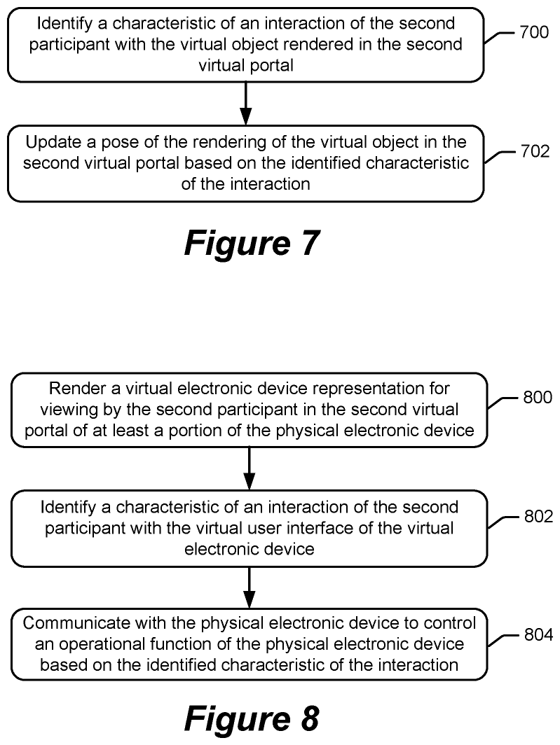

FIG. 7 is a flowchart of operations that can be performed by an XR rendering device in accordance with some embodiments of the present disclosure.

Referring to FIGS. 2 and 7, in some embodiments, operations further include identifying 700 a characteristic of an interaction of the second participant with the virtual object rendered in the second virtual portal. The operations also include updating 702 a pose of the rendering of the virtual object in the second virtual portal based on the identified characteristic of the interaction.

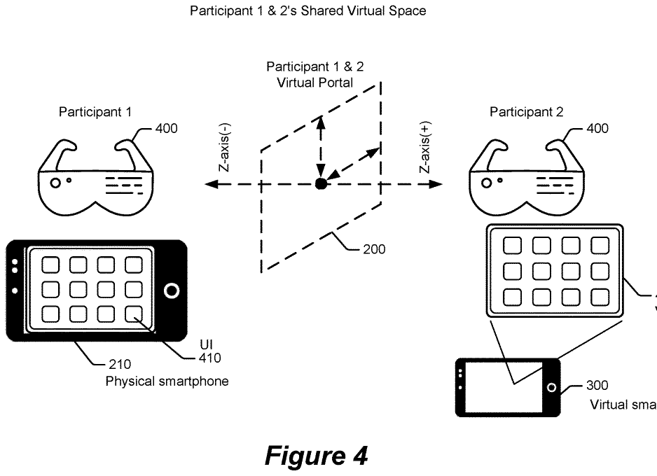

FIG. 4 illustrates an example virtual portal with a virtual user interface (UI) 420 displaying the content of the UI 410 of a physical smartphone 210, in accordance with some embodiments of the present disclosure.

FIG. 8 is a flowchart of operations that can be performed by an XR rendering device when a physical object 210 is a physical electronic device in accordance with some embodiments of the present disclosure.

Referring to FIGS. 2, 4, and 8, in some embodiments the physical object 210 is a physical electronic device, and the virtual object 300 is a virtual electronic device. The operations further include rendering 800 a virtual electronic device representation for viewing by the second participant in the second virtual portal 220 of at least a portion of the physical electronic device, wherein the rendering of the virtual electronic device comprises a virtual user interface that the second participant can interact with in the second virtual portal 220. The operations also include identifying 802 a characteristic of an interaction of the second participant with the virtual user interface of the virtual electronic device. The operations also include communicating 804 with the physical electronic device to control an operational function of the physical electronic device based on the identified characteristic of the interaction. A module may be executed by the XR rendering device 100 to track participant interactions with the rendering of the virtual electronic device and responsively translate those interactions into corresponding actions that are communicated to an interface module executed by the physical electronic device 210 to control operations of the physical electronic device 210.

The user interface 410 may have graphical objects with which a participant may interact. The virtual user interface 420 is a virtual representation of the user interface 410 of the physical smartphone 210. The virtual user interface 420 is visible through XR rendering devices such as the XR headset 400. As explained above, graphical objects may be icons or any graphical object which the participant is able to virtually press or otherwise interact. The virtual user interface 420 may be projected or displayed spaced apart from the virtual smartphone 300, such as illustrated in FIG. 4. The virtual user interface 420 may be the same shape and size as the user interface 410 on the physical smartphone 210 or may be scaled to a different size and/or have a different shape compared to the user interface 410 on the physical smartphone 210. The virtual user interface 420 may have a different layout than the user interface 410 of the physical smartphone 210.

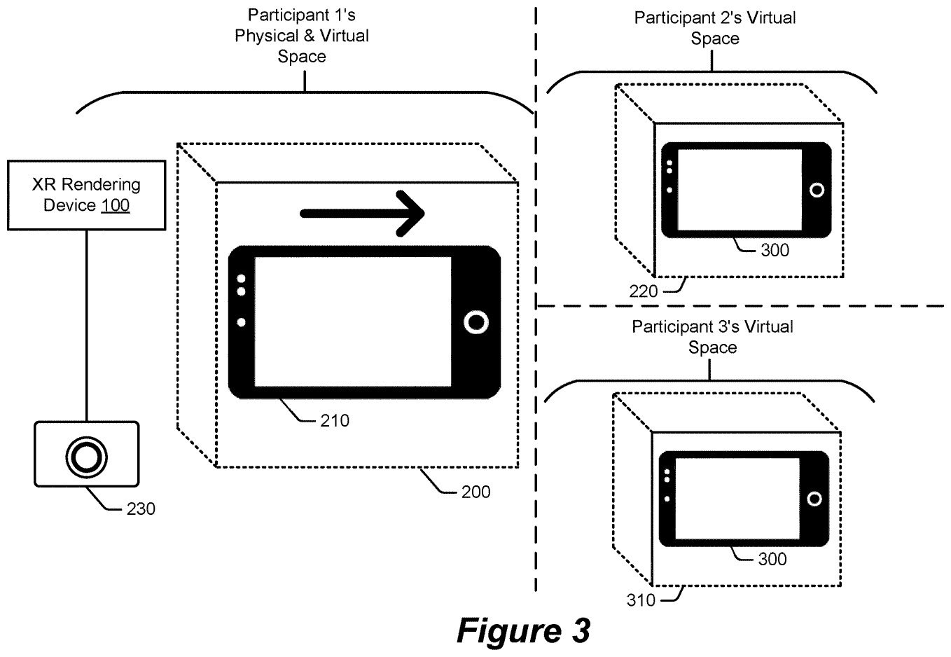

FIG. 3 is an example illustration of the XR rendering device 100 tracking location of a physical object 210 in the first participant's physical space while the physical object 210 is being passed through a virtual portal 200 and rendered in the virtual space of the immersive XR environment for a second participant and third participant, in accordance with some embodiments of the present disclosure. FIG. 3 illustrates a third virtual portal 310 in the third participant's virtual space.

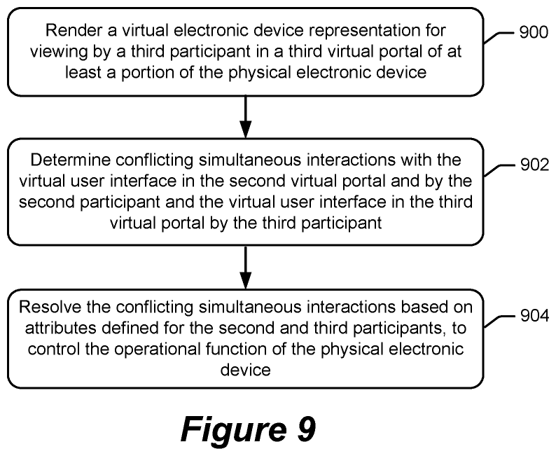

FIG. 9 is a flowchart of operations that can be performed by an XR rendering device in accordance with some embodiments of the present disclosure.

Referring to FIGS. 3 and 9, in some embodiments, the operations further include rendering 900 a virtual electronic device representation for viewing by a third participant, through a third XR device in a third virtual portal 310 of at least a portion of the physical electronic device, wherein the rendering of the virtual electronic device comprises a virtual user interface that the third participant can interact with in the third virtual portal 310. The operations also include determining 902 conflicting simultaneous interactions with the virtual user interface in the second virtual portal 220 and by the second participant and the virtual user interface in the third virtual portal 310 by the third participant. The operations also include resolving 904 the conflicting simultaneous interactions based on attributes defined for the second and third participants, to control the operational function of the physical electronic device.

In some embodiments the operations also include masking a portion of the virtual user interface viewable by the second participant based on determining information content to be displayed in the portion of the virtual user interface does not satisfy a permission attribute defined for the second participant.

In some embodiments, the second virtual portal 220 has a user access permission. The operations further comprise to limit an interaction of the second participant with the virtual object 300 rendered in the second virtual portal 220 of the second participant responsive to the user access permission of the second virtual portal 220.

As discussed in the previous embodiments, one of the participant-preferences or system settings may include access rules which may be dependent on a security class of participants, context of a virtual meeting, a number of participants, or other factors related to the virtual meeting.

For example, the virtual object 300 of a smartphone inside the virtual portal 200, 220, or 310 should preferrable not reveal unlock PIN-codes or passwords, unless the second participant has such access rights. In other embodiments, operations may mask a participant's finger selection of keys to enter PIN. The masking could be on the side of the first participant having the physical object (phone) so that other second and third participants would not see the first participant's movements and/or entries, and may be vice versa. The electronic object could automatically trigger the system to invoke masking responsive to entering into a defined operational mode associated with confidential information entry/display. Masking may correspond not displaying to the second and third participants some or all of the movement, freeze what is being rendered for display to the second and third participants, or displaying with a sufficiently high level of distortion, pixelation, or rendering an overlay over the virtual object 200 or 300.

Another example is e.g., a smartphone automatically (via an associated virtual object 300) changing its operation if inside or outside of the virtual portal 200. For example, when the first participant smartphone is inside virtual portal 200 then a private mode is blocked, while a work mode is available.

A third example is related to a second participant that uses the virtual object 300 representing the smartphone inside the virtual portal 220. The virtual user interface 420 will be limited to access rights and rules associated to the said participant and associated virtual object 300 may or may not change states accordingly. A second participant may be able to try certain functions that may or may not impact the virtual object 300.

Some embodiments are directed to persistence of virtual objects in the virtual portals.

In some embodiments, the first and second virtual portal has a time persistence attribute. The operations further comprise to cease rendering of the virtual object 300 representation of the physical object 210 viewable in the first virtual portal (200) by the first participant or the second virtual portal 220 by the second participant, responsive to the time persistence attribute of the second virtual portal 220 becoming satisfied.

In other words, in some of these embodiments, the physical object 210 may not only be held (for example by the first participant) and pushed through a two-dimensional membrane towards the second participant, but following some participant-invoked trigger action, be left as a persistent virtual object 300 inside the virtual portal 220.

A trigger action for the XR rendering device 100 indicating a time-persistent object may dependent upon a hand gesture, or controller command, or an object beacon, such as a keep-open signal transmitted from physical device.

A revoke of a persistent object may as result leave the virtual portal 200 or 220 open for further interaction of close upon departure; associated with an object-revoke closing action, a timer may be started that upon expiration and no further participant-interaction with the virtual portal 200 or 220, close virtual portal 200 or 220 or in a later step also close the virtual portal 200 or 220.

Related to the countdown timer expiration may also be associated closure or withdrawal not only of the digital object as a whole, but selected attributes (e.g., accesses) for the associated digital object. For example, a smartphone 210 is pushed beyond the virtual portal 220 and indicated as a time-persistent digital object with an in-virtual portal timer of a defined time length, such as 30 seconds, associated with the in-virtual portal timer is also an access-granted (for second participant) timer of 20 s and a not-interacted-with-timer of 5 seconds. However, the in-virtual portal timer is renewed as long as the physical object 210 remains in the virtual portal and/or the virtual object is interacted with. This would mean that the virtual object will be kept alive in the virtual portal for 30 seconds, accessible for second participant for 20 seconds. terminate automatically if the virtual object is not interacted with for more than 5 seconds.

Some embodiments are directed to merging attributes of multiple virtual portals.

As discussed above, sets of defined attributes may include at least one of: shape of the three-dimensional volume of a respective one of the first and second virtual portals; texture of a graphical membrane representing a surface boundary of the respective one of the first and second virtual portals; volume surface color of the graphical membrane of the respective one of the first and second virtual portals; volume surface transparency of the graphical membrane of the respective one of the first and second virtual portals; time persistence of the respective one of the first and second virtual portals; and user access permission for interaction with the virtual object rendered in the respective one of the first and second virtual portals.

In some embodiments, operations further include, based on determining an attribute merging condition has become satisfied, determining a subset of attributes common between the set of defined attributes of the first virtual portal of the first participant and the set of defined attributes of the second virtual portal 220 of the second participant. The operations also include, based on determining an attribute merging condition has become satisfied, applying the subset of attributes to the first virtual portal 200 of the first participant and the second virtual portal 220 of the second participant to control at least one of rendering of the virtual object 300 and controlling interaction with the virtual object 300.

The merging of attributes is discussed further in the following example. A first participant may have active virtual meeting sessions (VM) to at least two separate communication parties, such as a second and third participant. At some instance, first participant may desire to merge her two active virtual meeting sessions VMa (holding a virtual object VOa interacting with second participant A) and VMb (holding a virtual object VOb interacting with third participant B) into one session with a merged VMc with both participant A and participant B and respective digital objects VOa and VOb.

Then, system has to determine and render VMc according to merged VPV-size attributes for “VMa∩VMb (=VMab)” as well as determining and apply authorization and access rules in respect to e.g. participant A having certain access to VOa in VMab but not to VOb, whereas the other way around for participant B not having access to VOa but to VOb.

Further elaboration on merged digital object access rules for merged virtual portals may also consider participants inheriting access rules from other participant(s).

In a basic aspect, at least two empty (in terms on digital object non-populated) virtual portals may be merged typically considering only existing sizing attributes as authorization of any digital object may be considered in later method steps.

Virtual portal session-merge may be requested also from non-owning participant, where an ownership attribute is assigned to an owner of the physical object being inserted into the virtual portal.

Some embodiments are directed to splitting attributes of virtual portals.

In some embodiments, operations further include, based on determining an attribute splitting condition has become satisfied, apply the set of defined attributes of the first virtual portal to the first virtual portal 200 of the first participant to control at least one of rendering of the virtual object 300 and controlling interaction by the first participant with the virtual object 300. The operations also include, based on determining an attribute splitting condition has become satisfied, apply the set of defined attributes of the second virtual portal to the second virtual portal 220 of the second user to control at least one of rendering of the virtual object 300 and controlling interaction by the second participant with the virtual object 300.

Related to VPVs being merged as discussed above, operations may have the opposite procedure where one joint virtual portal holding multiple participants may be split into separate virtual portal meeting sessions holding respective session for first participant and the second participant (potentially encapsulating one virtual object A) and another virtual portal meeting session for first participant and the third participant (potentially encapsulating a same virtual object A and/or another virtual object B).

Correspondingly, in the aspect where digital objects in parent virtual portal are ending up in any of the split-up virtual portals, system may (re-)scale respective target virtual portal according to whatever virtual object is assigned thereto, or re-scaling the target virtual portal to a defined default size.

Some embodiments are directed to reusable objects in the virtual portals which may be stored in memory on the XR Rendering Device or accessible to the XR Rendering Device.

In some embodiments, operations further include saving to a data structure in memory the virtual object and the set of defined attributes associated with the second virtual portal 220. Operations also include cease rendering of the virtual object 300 in the second virtual portal 220. Operations also include, responsive to receiving a virtual object access command, render the virtual object 300 in the second virtual portal 220 and control interaction with the virtual object 300 based on retrieving the virtual object and the set of defined attributes associated with the second virtual portal 220 from the data structure in memory.

In some of these embodiments, physical objects which have been present in past, may have digital representation that is saved for future rendering based on a defined persistence rule.

In one embodiment, the participant may further have a stored virtual portal containing reusable virtual objects. When the rendering of the stored virtual portal is performed, any reusable virtual object is automatically rendered. The virtual object may be a previously established persistent object. If the virtual object has an internal state, the triggering of the stored virtual portal may further trigger an establishment/activation of a virtual object corresponding to the original physical object.

As an exemplifying use case, the stored virtual portal may contain a physical smartphone. The stored virtual portal was created at an earlier point in time where the physical smartphone was entered into the virtual portal. When the first participant triggers the stored virtual portal with the reusable virtual object, the virtual smartphone is rendered within the virtual portal. The first participant and any other participants active in the session may utilize the virtual smartphone as if the physical object had been entered after the rendering of the virtual portal.

Some embodiments are directed to virtual portal entrance surfaces.

In some embodiments, operations further include tracking a location on a surface boundary of the second virtual portal 220 where the second participant enters the second virtual portal 220 to interact with the virtual object 300. The operations also include determining an attribute from among a set of defined attributes to be applied to the second virtual portal 220 based on the location. The operations also include controlling interaction of the second participant with the virtual object 300 in the second virtual portal 220 based on the determined attribute.

In some embodiments, operations further include tracking a direction of entry of the second participant into the second virtual portal 220 to interact with the virtual object 300. The operations also include determining an attribute from among a set of defined attributes to be applied to the second virtual portal 220 based on the direction of entry. The operations also include controlling interaction of the second participant with the virtual object 300 in the second virtual portal 220 based on the determined attribute.

In some of these embodiments, the operation to determine an attribute from among the set of defined attributes to be applied to the second virtual portal 220 based on the direction of entry includes operations to determine at least one of the following as the determined attribute: user access permission for interaction by the second participant with the virtual object 300 rendered in the second virtual portal 220; priority of interaction by the second participant with the virtual object 300 rendered in the second virtual portal 220 relative to one or more other participants with the virtual object 300 in one or more other virtual portals; and time persistence of the virtual object 300 rendered in the second virtual portal 220 for interaction by the second participant.

In some of embodiments, a first participant may insert objects into the virtual portal 200 over one, defined, or all membrane surfaces associated with the virtual portal 200. Correspondingly, the same may apply also for any second participant.

In some embodiments, a certain entry-membrane may be prioritized for a certain participant. For example, the first participant may hold a highest priority to insert the physical object via a membrane surface facing the first participant or on a specified face of the virtual portal. In another example, each face of the virtual portal may apply different attributes to the virtual object such as: entering from the left makes the virtual object read-only, entering from the right makes the virtual object editable, entering from the top removes the virtual object or a feature of the virtual object, or entering from the bottom allows the other participants to run programs with the security privileges of another participant.

In other words, a direction of entry into the virtual portal may be tied to access privilege, priority, etc. Shape of the virtual portal may influence whether rules are associated with surfaces, such as a sphere may provide same access rule irrespective of direction versus rectangular surfaces associated with different access privileges/attributes. The direction of entry could also control whether the system analyzes and represents a new physical object being inserted versus tracking participant's hand for purpose of manipulating an already rendered virtual object. The direction of entry could also be interpreted as whether the physical object has electronic functionality that is to be recognized and allowed to be operated by another participant. For example, a smartphone entering a left face of the virtual portal may trigger the virtual object for another participant to be interactable according to defined rules, while the smartphone entering a right face of the virtual portal may trigger the virtual object for another participant to be a virtual representation only without the another participant having permission to interact with the virtual object according to defined rules.

Some embodiments are directed to virtual portal entrance surfaces.

In some embodiments, a first participant may scan and insert N physical objects into an active virtual portal. Then, depending on associated processing capabilities, said number N may be shared between participating participants according to policy X.

Physical objects 210 inserted into a virtual portal 200 may hold certain own prioritization (or sematic) attributes that determine a physical object is to be rendered in a position in the virtual object in relation to other virtual objects in general, or to other physical objects inserted by other participants. For example, a physical object of a class of physical objects may carry its own prioritization attributes in relation to other physical objects, or a physical object of a class of physical objects may inherit its inserting participant's priority attributers in relation to other participants. In other words, priority may affect where the physical object is rendered as a virtual object relative to the participant viewing the virtual object and/or relative to other rendered virtual objects, such as foreground versus background.

Temporarily inserted object may hold higher/lower in-virtual portal spatial priorities in relation to time-persistent virtual objects.

Some embodiments are directed to multiple participant parallel access to virtual objects in the virtual portals.

In some embodiments, operations further include, based on the determined attribute, resolving conflicting simultaneous interactions by the second participant with the virtual object 300 rendered in the second virtual portal 220 and a third participant with the virtual object 300 rendered in a third virtual portal 310.

In some embodiments with multiple participants interacting with same digital object inside a virtual portal, a first participant touching the virtual object, such as rotating the virtual object, may lock the virtual object for other participants' action as long as the first participant has control of virtual object. For example, these embodiments avoid a smartphone virtual rendering being rotated in two contradicting directions at the same time. These embodiments resolve simultaneous movements and/or virtual object operational control input based on priority, first-come, other rules.

### Example XR Rendering Device Configuration

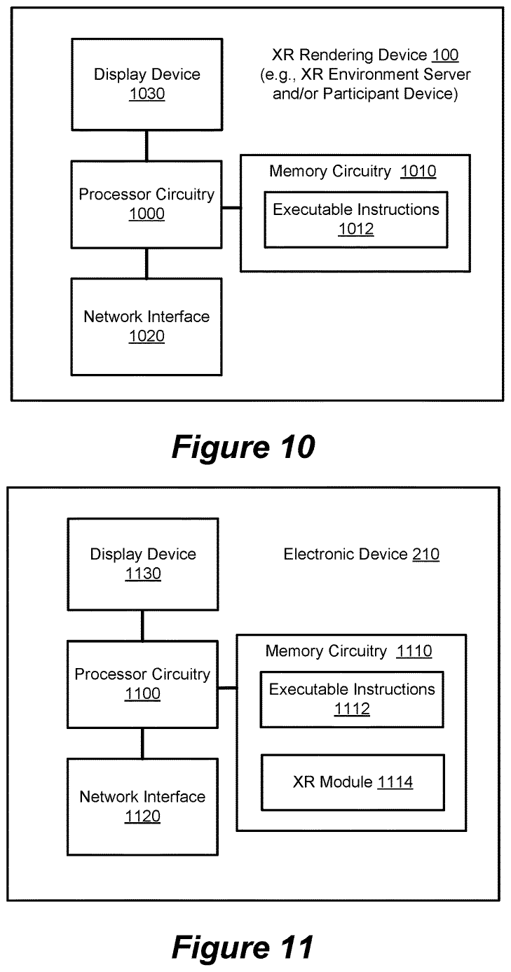

FIG. 10 is a block diagram of components of an XR rendering device 100 that are configured to operate in accordance with some embodiments of the present disclosure. The XR rendering device 100 can include processing circuitry, at least one network interface 1020 (network interface), and a display device 1030. The processing circuitry may include at least one processor circuit 1000 (processor), at least one memory 1010 (memory). The processor 1000 is operationally connected to these various components. The memory 1010 stores executable instructions 1012 that are executed by the processor 1000 to perform operations. The processor 1000 may include one or more data processing circuits, such as a general purpose and/or special purpose processor (e.g., microprocessor and/or digital signal processor), which may be collocated or distributed across one or more data networks. The processor 1000 is configured to execute the instructions 1012 in the memory 1010, described below as a computer readable medium, to perform some or all of the operations and methods for one or more of the embodiments disclosed herein for an XR rendering device. As explained above, the XR rendering device may be separate from and communicatively connected to the participant devices or may be at least partially integrated within one or more of the participant devices.

FIG. 11 is a block diagram of components of an electronic device 210 that are configured to operate in accordance with some embodiments of the present disclosure. The electronic device 210 can include processing circuitry, at least one network interface 1120 (network interface), and a display device 1130. The processing circuitry may include at least one processor circuit 1100 (processor), at least one memory 1110 (memory). The processor 1100 is operationally connected to these various components. The memory 1110 stores executable instructions 1112 and an XR module 1114 that are executed by the processor 1100 to perform operations. The processor 1100 may include one or more data processing circuits, such as a general purpose and/or special purpose processor (e.g., microprocessor and/or digital signal processor), which may be collocated or distributed across one or more data networks. The processor 1100 is configured to execute the instructions 1112 and XR module 1114 in the memory 1110, described below as a computer readable medium, to perform some or all of the operations and methods for one or more of the embodiments disclosed herein for an electronic device.

### Further Definitions and Embodiments

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

1. An extended reality, XR, rendering device for rendering an immersive XR environment on a display device for viewing by a second participant in the immersive XR environment, the XR rendering device comprising a processor circuitry adapted to perform operations to:
obtain parameters defining a first virtual portal having a three-dimensional volume at a location in physical space of a first participant;
track a location of a physical object relative to the three-dimensional volume of the first virtual portal; and
responsive to determining the physical object has entered the first virtual portal, render a virtual object representation of the physical object in a second virtual portal for viewing by the second participant.

2. The XR rendering device of claim 1, wherein the operations further comprise to:
render a graphical membrane representing a surface boundary of the first virtual portal in the immersive XR environment; and
track the location of the physical object relative to the location of the surface boundary,
wherein the rendering of the virtual object representation of the physical object is initiated based on determining the physical object has entered the surface boundary.

3-8. (canceled)

9. The XR rendering device of any of claim 1, wherein the first and second virtual portals each have a set of defined attributes, wherein each of the sets of defined attributes comprise at least one of:
shape of the three-dimensional volume of a respective one of the first and second virtual portals;
texture of a graphical membrane representing a surface boundary of the respective one of the first and second virtual portals;
volume surface color of the graphical membrane of the respective one of the first and second virtual portals;
volume surface transparency of the graphical membrane of the respective one of the first and second virtual portals;
time persistence of the respective one of the first and second virtual portals; and
user access permission for interaction with the virtual object rendered in the respective one of the first and second virtual portals.

10. The XR rendering device of any of claims 9, wherein the operations further comprise to:
based on determining an attribute merging condition has become satisfied,
determine a subset of attributes common between the set of defined attributes of the first virtual portal of the first participant and the set of defined attributes of the second virtual portal of the second participant, and
apply the subset of attributes to the first virtual portal of the first participant and the second virtual portal of the second participant to control at least one of rendering of the virtual object and controlling interaction with the virtual object.

11. The XR rendering device of claim 10, wherein the operations further comprise to:
based on determining an attribute splitting condition has become satisfied,
apply the set of defined attributes of the first virtual portal to the first virtual portal of the first participant to control at least one of rendering of the virtual object and controlling interaction by the first participant with the virtual object; and
apply the set of defined attributes of the second virtual portal to the second virtual portal of the second participant to control at least one of rendering of the virtual object and controlling interaction by the second participant with the virtual object.

12-16. (canceled)

17. A method performed by an extended reality, XR, rendering device for rendering an immersive XR environment on a display device for viewing by a second participant in the immersive XR environment, the method comprising:
obtaining parameters defining a first virtual portal having a three-dimensional volume at a location in physical space of a first participant;
tracking a location of a physical object relative to the three-dimensional volume of the first virtual portal; and
responsive to determining the physical object has entered the first virtual portal, rendering a virtual object representation of the physical object in a second virtual portal for viewing by the second participant.

18. The method of claim 17, further comprising:
rendering a graphical membrane representing a surface boundary of the first virtual portal in the immersive XR environment; and
tracking the location of the physical object relative to the location of the surface boundary,
wherein the rendering of the virtual object representation of the physical object is initiated based on determining the physical object has entered the surface boundary.

19-24. (canceled)

25. The method of claim 17, wherein the first and second virtual portals each have a set of defined attributes, wherein each of the sets of defined attributes comprise at least one of:
shape of the three-dimensional volume of a respective one of the first and second virtual portals;
texture of a graphical membrane representing a surface boundary of the respective one of the first and second virtual portals;
volume surface color of the graphical membrane of the respective one of the first and second virtual portals;
volume surface transparency of the graphical membrane of the respective one of the first and second virtual portals;
time persistence of the respective one of the first and second virtual portals; and
user access permission for interaction with the virtual object rendered in the respective one of the first and second virtual portals.

26. The method of claim 25, further comprising:
based on determining an attribute merging condition has become satisfied,
determining a subset of attributes common between the set of defined attributes of the first virtual portal of the first participant and the set of defined attributes of the second virtual portal of the second participant, and
applying the subset of attributes to the first virtual portal of the first participant and the second virtual portal of the second participant to control at least one of rendering of the virtual object and controlling interaction with the virtual object.

27. The method of claim 26, further comprising:
based on determining an attribute splitting condition has become satisfied,
applying the set of defined attributes of the first virtual portal to the first virtual portal of the first participant to control at least one of rendering of the virtual object and controlling interaction by the first participant with the virtual object; and
applying the set of defined attributes of the second virtual portal to the second virtual portal of the second participant to control at least one of rendering of the virtual object and controlling interaction by the second participant with the virtual object.

28-32. (canceled)

33. A computer program product comprising a non-transitory computer readable medium storing instructions executable by at least one processor of extended reality, XR, rendering device rendering an immersive XR environment on a display device for viewing by a second participant in the immersive XR environment, the instructions executed by the at least one processor perform operations comprising:
obtaining parameters defining a first virtual portal having a three-dimensional volume at a location in physical space of a first participant;
tracking a location of a physical object relative to the three-dimensional volume of the first virtual portal; and
responsive to determining the physical object has entered the first virtual portal, rendering a virtual object representation of the physical object in a second virtual portal for viewing by the second participant.
